(19) United States
(12) Patent Application Publication
(10) Pub. No.: US 2007/0164708 A1
(43) Pub. Date: Jul. 19, 2007

(54) Devices and methods for battery power management of electronic systems

(75) Inventor: Ming Yu Jiang, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/436,656

(22) Filed: May 18, 2006

(30) Foreign Application Priority Data
Jan. 17, 2006 (TW) TW95101696

(51) Int. Cl. H02J 7/00

(52) U.S. Cl. 320/132

(57) ABSTRACT

An embodiment of a method for battery power management comprises the following steps. A first power consumption magnitude indicating the amount of battery power consumed when the portable electronic device is in standby mode is calculated. A second power consumption magnitude indicating the amount of battery power consumed for a dynamic function to be activated is estimated. A power storage magnitude indicating the remaining power of the battery is acquired. The remaining battery life is calculated according to the first and second power consumption magnitudes and the power storage magnitude.

### BACKGROUND

The present invention relates to power management, and more particularly to devices and methods for battery power management of electronic systems.

Portable electronic devices are typically powered by charge storage devices such as batteries. The battery is generally rechargeable and made of alkaline batteries in the form of an enclosure type nickel cadmium (Ni—Cd) battery or nickel metal hydride-(Ni-MH) battery. Also, lithium ion (Li-ion) batteries of an organic electrolytic cell have been used in high-end portable electronic devices. Battery powered portable electronic devices typically require the capability to monitor power consumption from the battery so that the user can determine the remaining battery life before recharging or battery replacement is required.

### SUMMARY

Methods for battery power management, performed by a portable electronic device powered by a battery, are provided An embodiment of a method for battery power management comprises the following steps. A first power consumption magnitude indicating the amount of battery power consumed when the portable electronic device is in standby mode is calculated. A second power consumption magnitude indicating the amount of battery power consumed for a dynamic function to be activated is estimated. A power storage magnitude indicating the remaining power of the battery is acquired. The remaining battery life is calculated according to the first and second power consumption magnitudes and the power storage magnitude.

An embodiment of a method comprises the following steps. A request signal is received. The remaining battery life after admitting the request signal is calculated. A prompt message comprising the remaining battery life is notified to prompt users to confirm whether the portable electronic device executes an operation corresponding to the request signal. The request signal indicates that one of multiple dynamic functions is desired to be activated, or multiple original static settings are desired to be changed with multiple new static settings. The operation activates the requested dynamic function or changes the original static, settings with the new static settings.

An embodiment of a method comprises the following steps. A power consumption magnitude indicating the amount of battery power consumed for a dynamic function to be activated is estimated. A power storage magnitude indicating the remaining power of the battery is acquired. The remaining battery life is calculated according to the power consumption magnitude and the power storage magnitude.

Devices for battery power management of an electronic system are provided. The device comprises a battery and a control unit. An embodiment of a control unit coupling to the battery calculates a first power consumption magnitude indicating the amount of battery power consumed when the portable electronic device is in standby mode, estimates a second power consumption magnitude indicating the amount of battery power consumed for a dynamic function to be activated, acquires a power storage magnitude indicating the remaining power of the battery, and calculates the remaining battery life according to the first and second power consumption magnitudes and the power storage magnitude.

An embodiment of a control unit coupling to the battery receives a request signal, calculates the remaining battery life after admitting the request signal, and notifies a prompt message comprising the remaining battery life to prompt users to confirm whether that the portable electronic device executes an operation corresponding to the request signal. The request signal indicates that one of multiple dynamic functions is desired to be activated, or multiple original static settings are desired to be changed with multiple new static settings. The operation activates the requested dynamic function or changes the original static settings with the new static settings.

### BRIEF DESCRIPTION OF DRAWINGS

The invention will become more fully understood by referring to the following detailed description with reference to the accompanying drawings, wherein:

FIG. 1 is a diagram of hardware environment applicable to an embodiment of a mobile phone;

FIG. 2a is a diagram of an exemplary power consumption mapping table;

FIG. 2b is a diagram of an exemplary usage history table;

FIG. 2c is a diagram of an exemplary device configuration table;

FIG. 2d is a diagram of an exemplary function setting table;

FIGS. 3, 5 and 7 are flowcharts of embodiments of a battery power management, method;

FIGS. 4, 6a, 6b, 8a and 8b are diagrams of exemplary display screens;

FIG. 9 is a diagram of a storage medium storing a computer program for battery power management.

### DETAILED DESCRIPTION

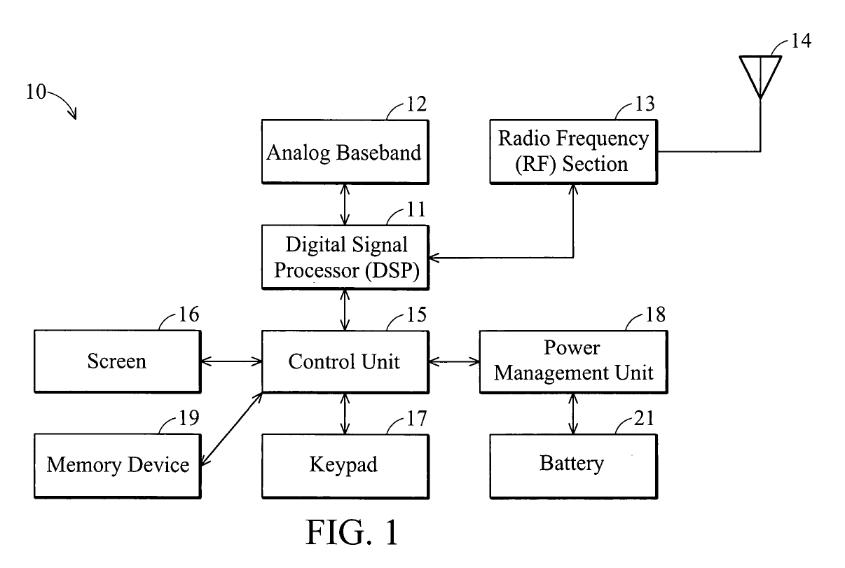

FIG. 1 is a diagram of hardware environment applicable to an embodiment of a mobile phone 10 comprising a digital signal processor (DSP) 11, an analog baseband 12, a radio frequency (RF) section 13, an antenna 14, a control unit 15; a screen 16, a keypad 17, a power management unit 18, a memory device 19 and a battery 21. The battery 21 may be a nickel cadmium (Ni—Cd), a nickel metal hydride (Ni-MH), a lithium ion (Li-ion) battery or similar. Moreover, those skilled in the art will understand that some embodiments may be practiced with other portable electronic devices, including personal digital assistants (PDAs), digital music (e.g. MP3) players, portable disk drives, portable programmable consumer electronics or similar. The control unit 15 may be a micro-processor (MPU) unit loading and executing program modules from the memory device 19 to perform battery power management methods. The memory device 19 is preferably a random access memory (RAM), but may also include read-only memory (ROM) or flash memory, storing program modules. The remaining power of the battery 21 is typically represented in milliampere (mA).

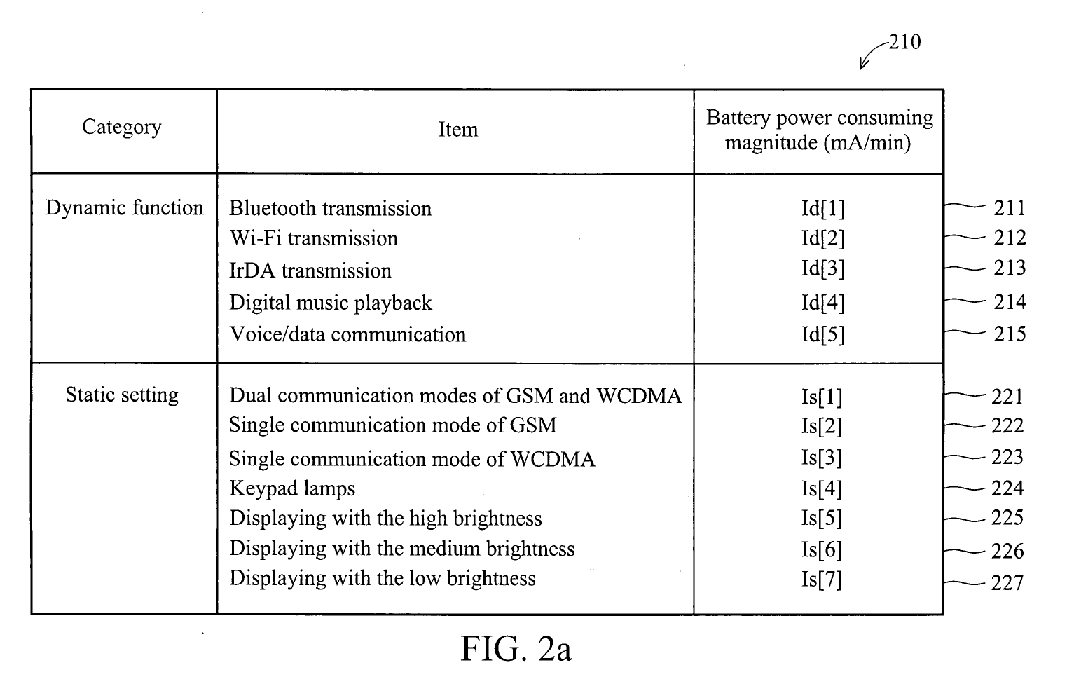

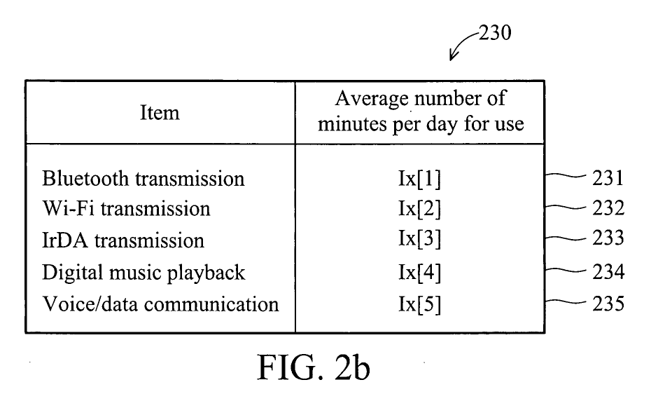

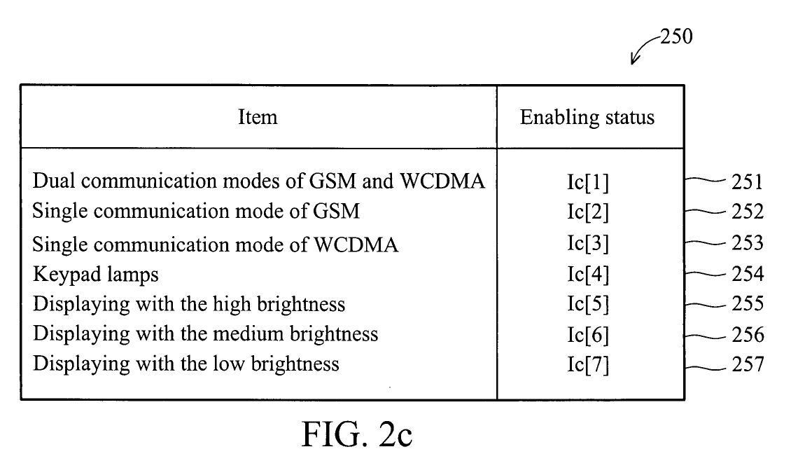

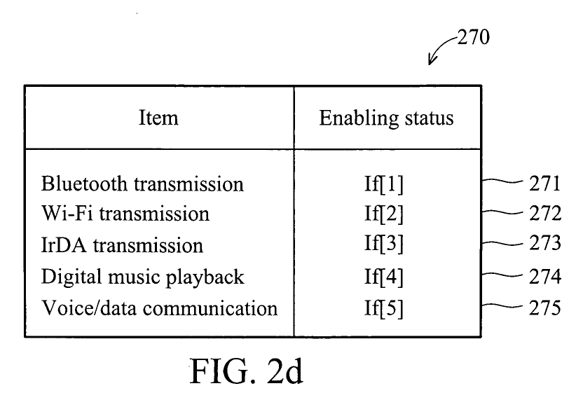

The memory device 19 stores a power consumption mapping table, a usage history table, a device configuration table and a function setting table. A power consumption mapping table contains multiple power consumption mapping records respectively storing information indicating the amount of battery power consumed per time unit (e.g. in mA per minute, mA/min) when a particular static setting or dynamic function is activated. FIG. 2a is a diagram of an exemplary power consumption mapping table 210 containing power consumption mapping records 211 to 227. The power consumption mapping records are divided into two categories, dynamic function mapping records 211 to 215 and static setting mapping records 221 to 227. Dynamic functions include Bluetooth transmission, Wi-Fi transmission, infrared rays association (IrDA) transmission, digital music playback, voice/data communication and similar. Those skilled in the art may provide information regarding additional or different dynamic functions in the power consumption mapping table 210. The power consumption records 211 to 215 respectively store information indicating the amount of battery power consumed per minute when Bluetooth transmission, Wi-Fi transmission, IrDA transmission, digital music playback and audio/data communication are activated. The battery power consumption magnitudes per minute, predefined constants, are respectively denoted as Id[1], Id[2], Id[3], Id[4] and Id[5]. Static settings include configuring the mobile phone 10 (FIG. 1) to activate the dual communication modes of GSM and WCDMA, the single communication mode of GSM, the single communication mode of WCDMA, keypad lamps, displaying with the high, medium and low brightness or similar. Those skilled in the art may provide information regarding additional or different static settings in the power consumption mapping table 210. The power consumption records 221 to 227 respectively store information indicating the amount of battery power consumed per minute when activating the dual communication modes of GSM and WCDMA, the single communication mode of GSM, the single communication mode of WCDMA, keypad lamps, displaying with the high, medium and low brightness. The battery power consumption magnitudes per minute, predefined constants, are respectively denoted as Is[1], Is[2], Is[3], Is[4], Is[5], Is[6] and Is[7].

A usage history table contains multiple usage history records respectively storing information indicating average time (e.g. in minutes) per day of use for a particular dynamic function resident on the mobile phone 10. FIG. 2b is a diagram of an exemplary usage history table 230 containing multiple usage history records 231 to 235. The usage history records 231 to 235 respectively store information indicating the average number of minutes per day for use of Bluetooth transmission, Wi-Fi transmission, IrDA transmission, digital music playback and voice/data communication. The average minutes in one day are respectively denoted as Ix[1], Ix[2], Ix[3], Ix[4] and Ix[5]. When the control unit 15 (FIG. 1) detects that average time of use per day for a particular dynamic function varies, the corresponding usage history record is updated with the newly detected value.

A device configuration table contains multiple device configuration records respectively storing information indicating enabling statuses of static settings. FIG. 2c is a diagram of an exemplary device configuration table 250 containing multiple device configuration records 251 to 257. The device configuration records 251 to 257 respectively store information indicating enabling statuses for activating the dual communication modes of GSM and WCDMA, the single communication mode of GSM, the single communication mode of WCDMA, keypad lamps, displaying with the high, medium and low brightness The enabling statuses are respectively denoted as Ic[1], Ic[2], Ic[3], Ic[4], Ic[5], Ic[6] and Ic[7]. When a specific static setting is activated, the corresponding enabling status is set to “1”, and otherwise, to “0”.

A function setting table contains multiple function setting records respectively storing information indicating enabling statuses of dynamic functions. FIG. 2d is a diagram of an exemplary function setting table 270 containing multiple function setting records 271 to 275. The function setting records 271 to 275 respectively store information indicating enabling statuses for activating Bluetooth transmission, Wi-Fi transmission, infrared rays association (IrDA) transmission, digital music playback and voice/data communication. The enabling statuses are respectively denoted as If[1], If[2], If[3], If[4], If[5] and If [6]. When a specific dynamic function is activated, the corresponding enabling status is set to “1”, and otherwise, to “0”.

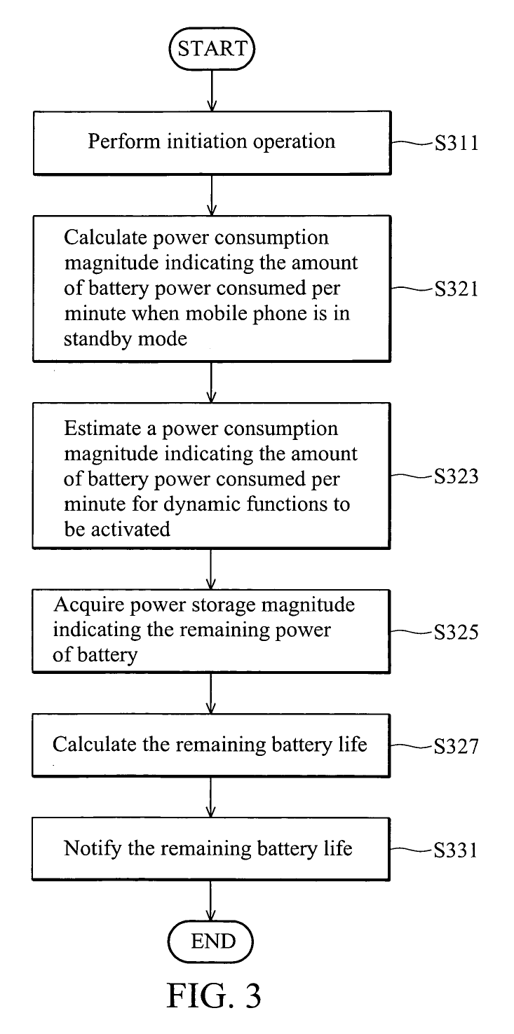

FIG. 3 is a flowchart of an embodiment of a battery power management method performed by control unit 15. In step S311, an initiation operation is performed when the mobile phone 10 is powered on. In step S321, a power consumption magnitude is calculated to indicate the amount of battery power consumed per minute when the mobile phone 10 is in standby mode. Step S321 may read the static setting mapping records 221 to 227 (FIG. 2a) from the power consumption mapping table 210 (FIG. 2a), and the device configuration records 251 to 257 (FIG. 2c) from the device configuration table 250 (FIG. 2c), and calculate such power consumption magnitude by the following formula:

$${IS}_{total} = {\sum }_{i = 1}^{n} Is [ i ] \times Ic [ i ] ,$$

where n represents a quantity of static settings, Is[i] represents a magnitude indicating the amount of battery power consumed per minute for the ith static setting, Ic[i] represents an enabling status for the ith static setting. When the ith static setting is activated, c[i]=“1”, otherwise, when the ith static setting is deactivated Ic[i]=“0”.

In step S323, a power consumption magnitude is estimated to indicate the amount of battery power consumed per minute for dynamic functions to be activated. Step S323 may read the dynamic fluction mapping records 211 to 215 (FIG. 2a) from the power consumption mapping table 210 (FIG. 2a), and the usage history records 231 to 235 (FIG. 2b) from the usage history table 230 (FIG. 2b), and estimate such power consumption magnitude by the following formula:

$${ID}_{total} = ( {\sum }_{j = 1}^{m} Id [ j ] \times Ix [ j ] ) / 1440 ,$$

where m represents a quantity of dynamic functions, Id[j] represents a magnitude indicating the amount of battery power consumed per minute for the jth dynamic function, Ix[j] represents an average usage time (in minutes) per day for the jth dynamic function and the constant 1440 represents the total number of minutes in one day.

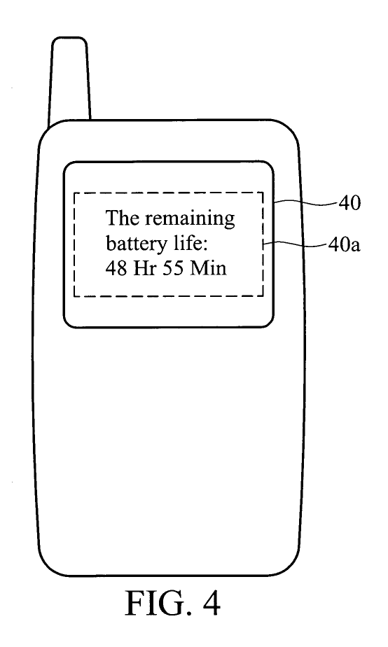

In step S325, a power storage magnitude (in mA) indicating the remaining power, of the battery 21 is acquired. The power storage magnitude may be acquired via the power management unit 18 (FIG. 1). In step S327, the remaining battery life is calculated according to the above two power consumption magnitudes and the power storage magnitude. Step S327 may calculate the remaining battery life by the following formula:
Tr=Bₜₒₜₐₗ/(ISₜₒₜₐₗ+IDₜₒₜₐₗ),
where Bₜₒₜₐₗ represents the acquired power storage magnitude, ISₜₒₜₐₗ represents the calculated power consumption magnitude indicating the amount of battery power consumed per minute when the mobile phone 10 is in standby mode, and IDₜₒₜₐₗ represents the estimated power consumption magnitude indicating the amount of battery power consumed per minute for dynamic functions to be activated. Note that, when estimating the remaining battery life, IDₜₒₜₐₗ is a usage estimation factor corresponding to dynamic functions resident on the mobile phone 10 (FIG. 1), determined by considering historical use of dynamic functions. For example, when two mobile phones are configured to apply the same static settings, the remaining battery life corresponding to one mobile phone having a higher IDₜₒₜₐₗ, is lower than that corresponding to the other mobile phone having lower IDₜₒₜₐₗ. In step S331, the remaining battery life is notified. FIG. 4 is a diagram of an exemplary display screen 40 displaying the remaining battery life 401. Alternatively, voices data corresponding to the remnaining battery life is played to notify users.

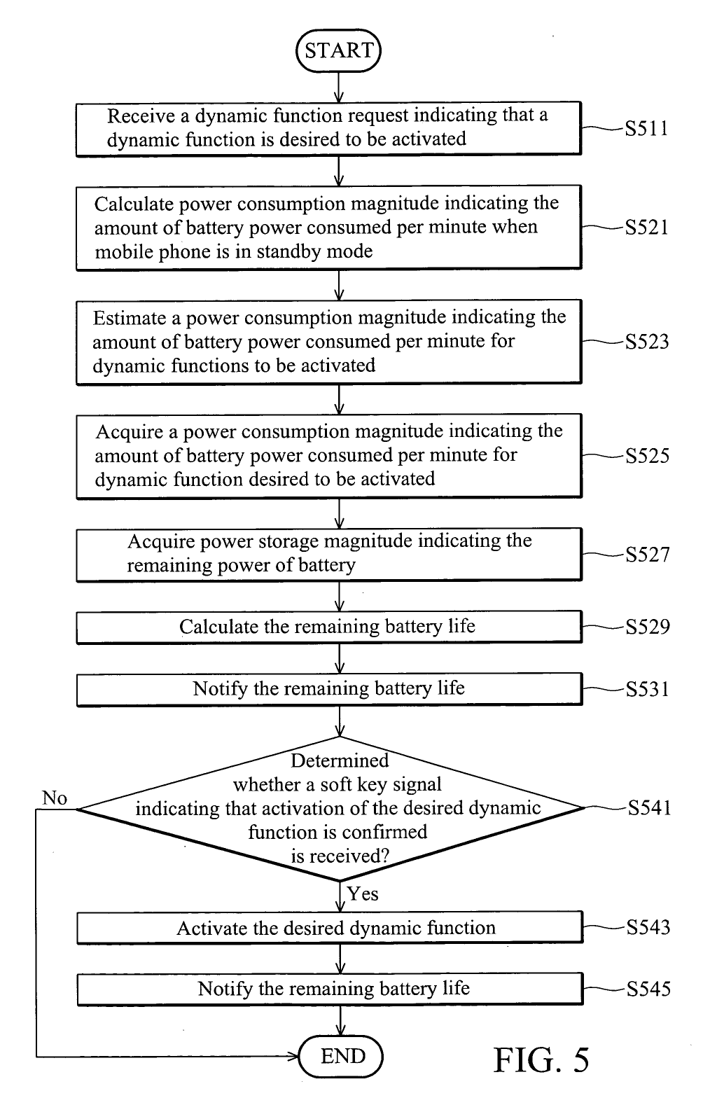

FIG. 5 is a flowchart of an embodiment of a battery power management method, performed by the control unit 15. In step S511, a dynamic function request indicating that a dynamic function such as Bluetooth transmission, Wi-Fi transmission, IrDA transmission, digital music playback, voice/data communication or similar, is desired to be activated is received. In step S521, a power consumption magnitude is calculated to indicate the amount of battery power consumed per minute when the mobile phone 10 is in standby mode. Note that no dynamic functions are activated when the mobile phone 10 is in standby mode. Step S521 may read the static setting mapping records 221 to 227 (FIG. 2a) from the power consumption mapping table 210 (FIG. 2a), and the device configuration records 251 to 257 (FIG. 2c) from the device configuration table 250 (FIG. 2c), and calculate such power consumption magnitude ISₜₒₜₐₗ by a formula as described in step S321. In step S523, a power consumption magnitude is estimated to indicate the amount of battery power consumed per minute for dynamic functions to be activated. Step S523 may read the dynamic function mapping records 211 to 215 (FIG. 2a) from the power consumption mapping table 210 (FIG. 2a), and the usage history records 231 to 235 (FIG. 2b) from the usage history table 230 (FIG. 2b), and estimate such power consumption magnitude IDₜₒₜₐₗ by a formula as described in step S323.

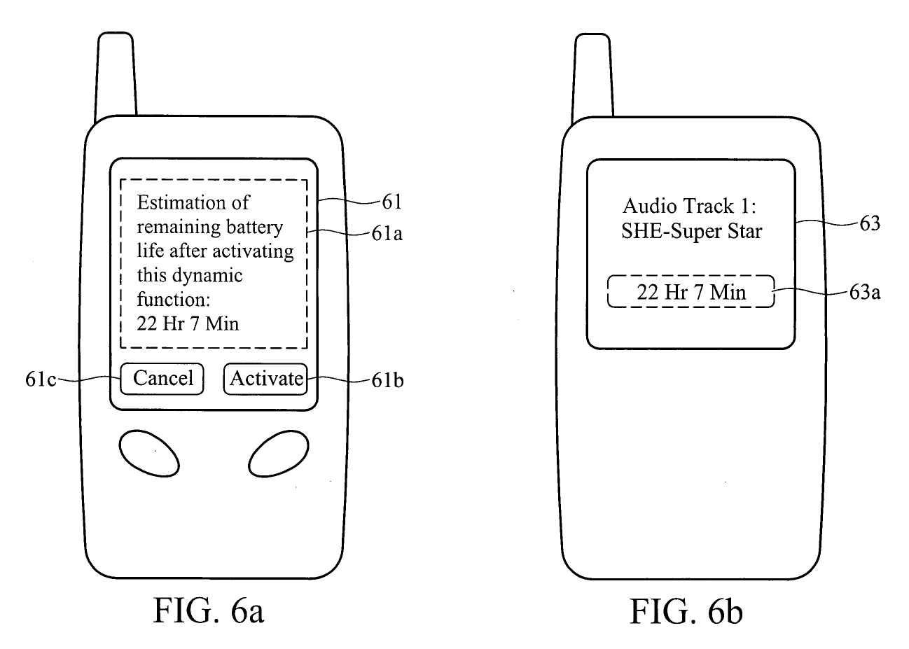

In step S525; a power consumption magnitude is acquired to indicate the amount of battery power consumed per minute for the dynamic function desired to be activated. Step S525 may read the dynamic function mapping records 211 to 215 (FIG. 2a) from the power consumption mapping table 210 (FIG. 2a) to acquire such power consumption magnitude IDₜₑₘₚ. In step S527, a power storage magnitude: (in mA) indicating the remaining power of the battery 21 is acquired. The power storage magnitude may be acquired via the power management unit 18 (FIG. 1). In step S529, the remaining battery life is calculated according to the above three power consumption magnitudes and the power storage magnitude. Step S529 may calculate the remaining battery life by the following formula:
Tr=Bₜₒₜₐₗ/(ISₜₒₜₐₗ+IDₜₒₜₐₗ+IDₜₑₘₚ),
where Bₜₒₜₐₗ represents the acquired power storage magnitude, ISₜₒₜₐₗ represents the calculated power consumption magnitude indicating the amount of battery power consumed per minute when the mobile phone 10 is in standby mode, IDₜₒₜₐₗ represents the estimated power consumption magnitude indicating the amount of battery power consumed per minute for dynamic functions to be activated, and IDₜₑₘₚ represents the acquired power consumption magnitude indicating the amount of battery power consumed per minute for a dynamic function desired to be activated. In step S531, the remaining battery liife is notified. A prompt message is displayed via the screen 16 (FIG. 1) to show the rermaining battery life and ask a user to confirm whether to activate the desired dynamic function. Alternatively, voice data corresponding to the remaining battery life is played to notify users. FIG. 6a is a diagram of an exemplary display screen 61 displaying the remaining battery life 61a with two soft keys 61b and 61c for allowing a user to confirm whether to activate the desired dynamic function. In step S541, it is determined whether a soft key signal indicating that activation of the desired dynamic function is confirmed is received. If so, the process proceeds to step S543, otherwise, the process ends. In step S543, the desired dynamic function is activated. In step S545, the remaining battery life is notified. FIG. 6b is a diagram of an exemplary display screen 63 displaying the remaining battery life 63a. Alternatively, voice data corresponding to the remaining battery life is played to notify users.

In some embodiments, steps S523 and S525 may be combined into a single step. The combined step may read the static setting mapping records 221 to 227 (FIG. 2a) from the power consumption mapping table 210 (FIG. 2a), the usage history records 231 to 235 (FIG. 2b) from the usage history table 230 (FIG. 2b), and the function setting records 271 to 275 (FIG. 2d) from the function setting table 270 (FIG. 2d), and subsequently, update a function setting record corresponding to the dynamic function request with “1”. In an aspect for considering that the voice/data communication is the most important dynamic function in estimating the remaining battery life, the, function setting record 275 may further be updated with “1”. when the dynamic function request does not correspond to voice/data comnmunication. A power consumption magnitude indicating the amount of battery power consumed per minute for dynamic functions to be activated may be calculated by the following formula:

$${ID}_{total} = ( {\sum }_{j = 1}^{m} Id [ j ] \times Ix [ j ] \times If [ j ] ) / 1440 ,$$

where m represents a quantity of dynamic functions, Id[j] represents a magnitude indicating the amount of battery power consumed per minute for the jth dynamic function, Ix[j] represents an average usage time (in minute) per day for the jth dynamic function, If[j] represents an enabling status for the jth dynamic function and the constant 1440 represents the total number of minutes in one day. When the jth dynamic function is activated, If[j]=“1”, otherwise, when the jth dynamic function is deactivated, If[j]=“0”. Furthermore, the formula for calculating the remaining battery life described in step S529 is replaced with a formula described in step S327.

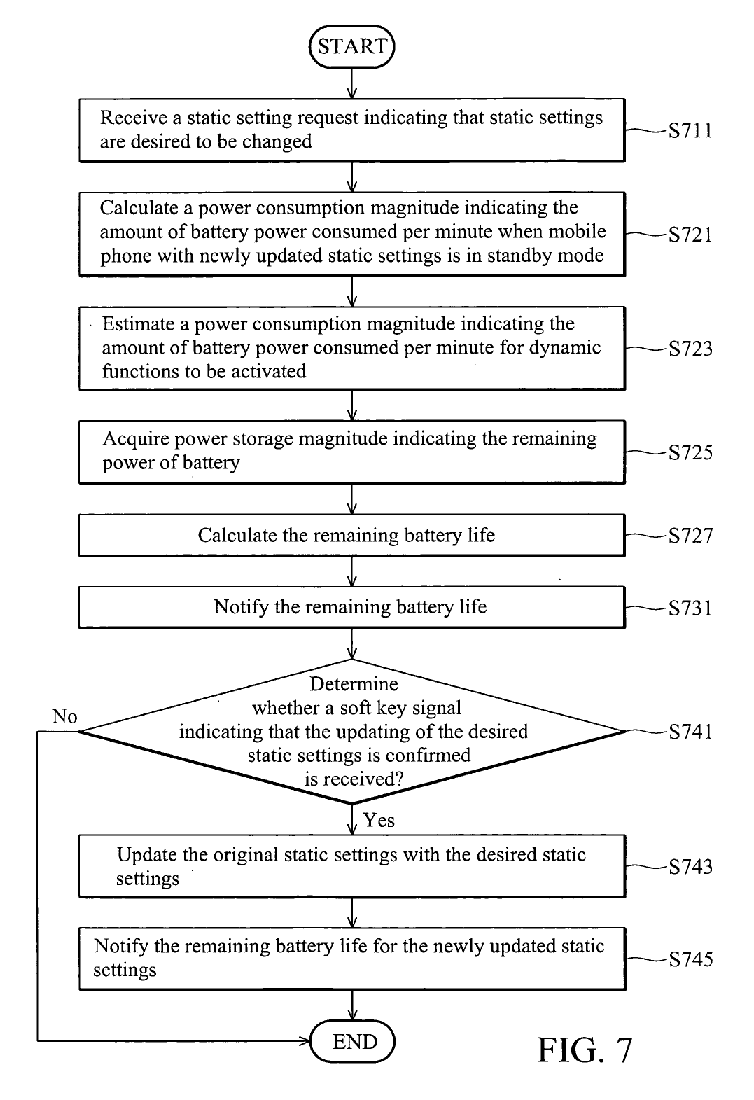

FIG. 7 is a flowchart of an embodiment of a battery power management method, performed by the control unit 15. In step S711, a static setting request indicating that static settings are desired to be changed is received. For example, the static setting request indicating that static settings for displaying with the highest brightness are changed to static settings for displaying with the lowest brightness, or static settings for activating the single communication mode of GSM are changed to static settings for activating the dual communication modes of GSM and WCDMA. In step S721, a power consumption magnitude is calculated to indicate the amount of battery power consumed per minute when the mobile phone 10 with newly updated static settings is in standby mode. Step S721 may read the static setting mapping records 221 to 227 (FIG. 2a) from the power consumption mapping table 210 (FIG. 2a), and the device configuration records 251 to 257 (FIG. 2c) from the device configuration table 250 (FIG. 2c), modifies the device configuration records 251 to 257 according to the static setting request, and calculates such power consumption magnitude ISₜₒₜₐₗ by a formula with the newly updated static settings, the formula as described in step S321. In step S723, a power consumption magnitude is estimated to indicate the amount of battery power consumed per minute for dynamic functions to be activated. Step S723 may read the dynamic function mapping records 211 to 215 (FIG. 2a) from the power consumption mapping table 210 (FIG. 2a), and the usage history records, 231 to 235 (FIG. 2b) from the usage history table 230 (FIG. 2b), and estimate such power consumption magnitude IDₜₒₜₐₗ by a formula as described in step S323.

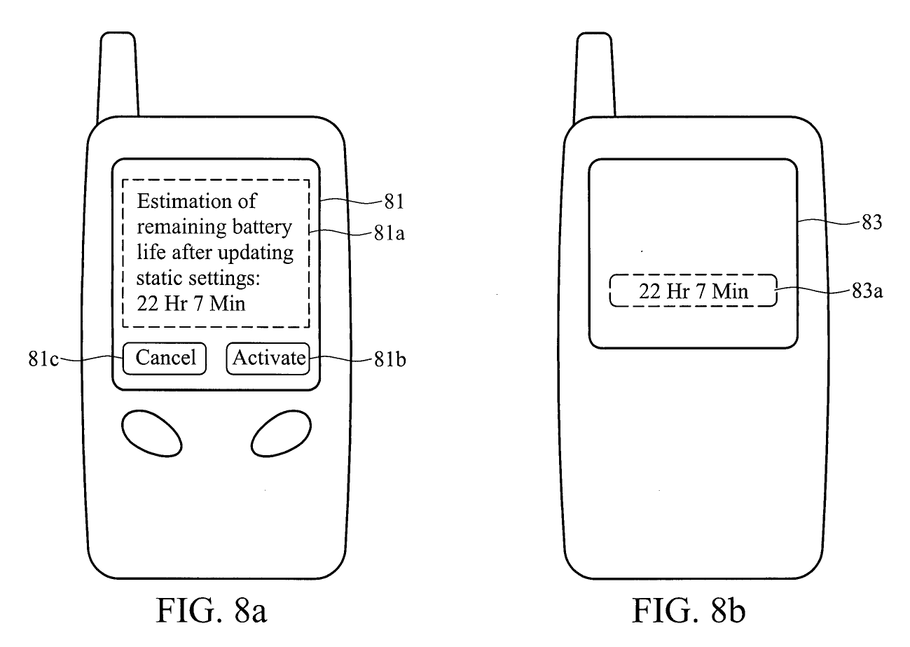

In step S725, a power storage magnitude (in mA) indicating the remaining power of the battery 21 is acquired. The power storage magnitude may be acquired via the power management unit 18 (FIG. 1). In step S727, the remaining battery life for the newly updated static settings is calculated by a formula as described in step S327. In step S731, the remaining battery life is notified. A prompt message is displayed via the screen 16 (FIG. 1) to display the remaining battery life for the newly updated static settings and allow a user to confirm whether to update the original static settings. Alternatively, voice data corresponding to the remaining battery life is played to notify users. FIG. 8a is a diagram of an exemplary display screen 81 displaying the remaining battery life 81a with two soft keys 81b and 81c for allowing a user to confirm whether to update the original static settings In step S741, it is determined whether a soft key signal indicating that the updating of the desired static settings is confirmed is received. If so, the process proceeds to step S743, otherwise, the process ends. In step S743, the original static settings are updated with the desired static settings. In step S745, the remaining battery life for the newly updated static settings is notified. FIG. 8b is a diagram of an exemplary display screen 83 displaying the remaining battery life 83a. Alternatively, voice data corresponding to the remaining battery life for the newly updated static settings is played to notify users.

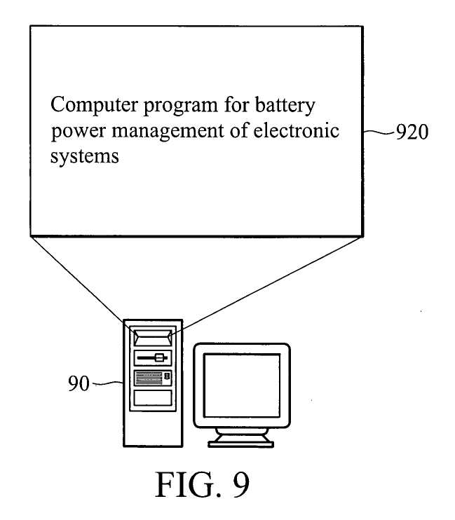

Also disclosed is a storage medium as shown in FIG. 9 storing a computer program 920 providing the disclosed methods for battery power management of electronic systems. The computer program includes a storage medium 90 having computer readable program code therein for use in a computer system. The computer readable program code comprises computer logic described in FIGS. 3, 5 and 7.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that,operates analogously to specific logic circuits.

Certain terms are used throughout the description and claims to refer to particular systems components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A method for battery power management, performed by a portable electronic device powered by a battery, comprising:
calculating a first power consumption magnitude indicating the amount of battery power consumed when the portable electronic device is in standby node;
estimating a second power consumption magnitude indicating the amount of battery power consumed for a dynamic function to be activated; acquiring a power storage magnitude indicating the remaining power of the battery; and
calculating the remaining battery life according to the first and second power consumption magnitudes and the power storage magnitude.

2. The method as claimed in claim 1 wherein the first power consumption magnitude indicates the amount of battery power consumed per minute when the portable electronic device is in standby mode, and is calculated by a formula:
$${IS}_{total} = {\sum }_{i = 1}^{n} Is [ i ] \times Ic [ i ] ,$$
n representing a quantity of static settings, Is[i] representing a magnitude indicating the amount of battery power consumed per minute for the ith static setting, Ic[i] representing an enabling status for the ith static setting, and, when the ith static setting is activated, Ic[i]=“1”, otherwise, Ic[i]=“0”.

3. The method as claimed in claim 2 further comprising:
acquiring the magnitude indicating the amount of battery power consumed per minute for each static setting by reading a power consumption mapping table; and
acquiring the enabling status for each static setting by reading a device configuration table.

4. The method as claimed in claim 1 wherein the second power consumption magnitude indicating the amount of battery power consumed per minute for the dynamic function to be activated, and is calculated by a formula:
$${ID}_{total} = ( {\sum }_{j = 1}^{m} Id [ j ] \times Ix [ j ] ) / 1440 ,$$
m representing a quantity of dynamic functions, Id[j] representing a magnitude indicating the amount of battery power consumed per minute for the jth dynamic function, and Ix[j] representing an average usage time (in minutes) per day for the jth dynamic function.

5. The method as claimed in claim 4 wherein further comprising:
acquiring the magnitude indicating the amount of battery power consumed per minute for each dynamic function by reading a power consumption mapping table; and
acquiring the average usage time (in minutes) per day for each dynamic function by reading a usage history table.

6. The method as claimed in claim 1 wherein the remaining battery life is calculated by a formula,
Tr=Bₜₒₜₐₗ/(ISₜₒₜₐₗ+IDₜₒₜₐₗ),
Bₜₒₜₐₗ representing the acquired power storage magnitude, ISₜₒₜₐₗ representing the first power consumption magnitude, and IDₜₒₜₐₗ representing the second power consumption magnitude.

7. The method as claimed in claim 1 further comprising notifying the remaining battery life.

8. A device for battery power management of an electronic system, comprising:
a battery; and
a control unit coupling to the battery, calculating a first power consumption magnitude indicating the amount of battery power consumed when the portable electronic device is in standby mode, estimating a second power consumption magnitude indicating the amount of battery power consumed for a dynamic function to be activated, acquiring a power storage magnitude indicating the remaining power of the battery, calculating the remaining battery life according to the first and second power consumption magnitudes and the power storage magnitude, and notifying the remaining battery life.

9. The device as claimed in claim 8 wherein the first power consumption magnitude indicates the amount of battery power consumed per minute when the portable electronic device is in standby mode, and is calculated by a formula:
$${IS}_{total} = {\sum }_{i = 1}^{n} Is [ i ] \times Ic [ i ] ,$$
n representing a quantity of static settings, Is[i] representing a magnitude indicating the amount of battery power consumed per minute for the ith static setting, Ic[i] representing an enabling status for the ith static setting, and, when the ith static setting is activated, Ic[i]=“1”, otherwise, Ic[i]=“0”.

10. The device as claimed in claim 8 wherein the second power consumption magnitude indicating the amount of battery power consumed per minute for the dynamic flinction to be activated, and is calculated by a formula:
$${ID}_{total} = ( {\sum }_{j = 1}^{m} Id [ j ] \times Ix [ j ] ) / 1440 ,$$
m representing a quantity of dynamic functions, Id[j] representing a magnitude indicating the amount of battery power consumed per minute for the jth dynamic function, and Ix[f] representing an average usage time (in minutes) per day for the jth dynamic function.

11. The device as claimed in claim 8 wherein the remaining battery life is calculated by a formula,
Tr=Bₜₒₜₐₗ/(ISₜₒₜₐₗ+IDₜₒₜₐₗ),
Bₜₒₜₐₗ representing the acquired power storage magnitude, ISₜₒₜₐₗ representing the first power consumption magnitude, and IDₜₒₜₐₗ representing the second power consumption magnitude.

12. The device as claimed in claim 8 further comprising a screen, wherein the control unit further directs the screen to display the remaining battery life.

13. A method for battery power management, performed by a portable electronic device powered by a battery, comprising:
receiving a request signal;
calculating the remaining battery life after admitting the request signal; and
notifying a prompt message comprising the remaining battery life to prompt users to confirm whether the portable electronic device executes an operation corresponding to the request signal,
wherein the request signal indicates that one of a plurality of dynamic functions is desired to be activated, or a plurality of original static settings are desired to be changed with a plurality of new static settings, and the operation activates the requested dynamic function or changes the original static settings with the new static settings.

14. The method as claimed in claim 13 wherein the request signal indicates that the dynamic, functions is desired to be activated, and the operation activates the requested dynamic function, the calculation step further comprising:
calculating a first power consumption magnitude indicating the amount of battery power consumed when the portable electronic device is in standby mode;
estimating a second power consumption magnitude indicating the amount of battery power consumed for the dynamic functions potentially to be activated;
acquiring a third power consumption magnitude indicating the amount of battery power consumed for the requested dynamic function;
acquiring a power storage magnitude indicating the remaining power of the battery; and
calculating the remaining battery life according to the first, second and third power consumption magnitudes and the power storage magnitude.

15. The method as claimed in claim 14 wherein the first power consumption magnitude indicates the amount of battery power consumed per minute when the portable electronic device is in standby mode, and is calculated by a formula:
$${IS}_{total} = {\sum }_{i = 1}^{n} Is [ i ] \times Ic [ i ] ,$$
n representing a quantity of static settings, Is[i] representing a magnitude indicating the amount of battery power consumed per minute for the ith static setting, Ic[i] representing an enabling status for the ith static setting, when the ith static setting is activated, Ic[i]=“1”, otherwise, Ic[i]=“0”, the second power consumption magnitude indicates the amount of battery power consumed per minute for the dynamic functions potentially to be activated, and is calculated by a formula:
$${ID}_{total} = ( {\sum }_{j = 1}^{m} Id [ j ] \times Ix [ j ] ) / 1440 ,$$
m representing a quantity of dynamic functions, Id[j] representing a magnitude indicating the amount of battery power consumed per minute for the jth dynamic function, and Ix[j] representing an average usage time (in minutes) per day for the jth dynamic function, and, the remaining battery life is calculated by a formula,
Tr=Bₜₒₜₐₗ/(ISₜₒₜₐₗ+IDₜₒₜₐₗ+IDₜₑₘₚ),
Bₜₒₜₐₗ representing the acquired power storage magnitude, ISₜₒₜₐₗ representing the first power consumption magnitude, IDₜₒₜₐₗ representing the second power consumption magnitude, and IDₜₑₘₚ representing the third power consumption magnitude.

16. The method as claimed in claim 13 the request signal indicates that the dynamic functions are desired to be activated, and the operation activates the requested dynamic function, the calculation step further comprising:
calculating a first power consumption magnitude indicating the amount of battery power consumed when the portable electronic device is in standby mode;
estimating a second power consumption magnitude indicating the amount of battery power consumed for the dynamic functions potentially to be activated;
acquiring a power storage magnitude indicating the remaining power of the battery; and
calculating the remaining battery life according to the first and second power consumption magnitudes and the power storage magnitude.

17. The method as claimed in claim 16 wherein the first power consumption magnitude indicates the amount of battery power consumed per minute when the portable electronic device is in standby mode, and is calculated by a formula:
$${IS}_{total} = {\sum }_{i = 1}^{n} Is [ i ] \times Ic [ i ] ,$$
n representing a quantity of static settings, Is[i] representing a magnitude indicating the amount of battery power consumed per minute for the ith static setting, Ic[i] representing an enabling status for the ith static setting, when the ith static setting is activated, Ic[i]=“1”, otherwise, Ic[i]=“0”, the second power consumption magnitude indicates the amount of battery power consumed per minute for the dynamic functions potentially to be activated, and is calculated by a formula:
$${ID}_{total} = ( {\sum }_{j = 1}^{m} Id [ j ] \times Ix [ j ] \times If [ j ] ) / 1440 ,$$
m representing a quantity of dynamic functions, Id[j] representing a magnitude indicating the amount of battery power consumed per minute for the jth dynamic function, Ix[j] representing an average usage time (in minutes) per day for the jth dynamic function, and If[j] representing an enabling status for the jth dynamic function, when the jth dynamic function is activated, If[i]=“1”, otherwise, If [i]=“0”, and, the remaining battery life is calculated by a formula,
Tr=Bₜₒₜₐₗ/(ISₜₒₜₐₗ+IDₜₒₜₐₗ),
Bₜₒₜₐₗ representing the acquired power storage magnitude, ISₜₒₜₐₗ representing the first power consumption magnitude, and IDₜₒₜₐₗ representing the second power consumption magnitude.

18. The method as claimed in claim 17 wherein the enabling status of the dynamic function corresponding to voice/data communication is set to “1”.

19. The method as claimed in claim 13 wherein the request signal indicates that the original static settings are desired to be changed with the new static settings, and the operation changes the static settings with the new static settings, the calculation step further comprising:
calculating a first power consumption magnitude indicating the amount of battery power consumed when the portable electronic device with the new static settings is in standby mode;
estimating a second power consumption magnitude indicating the amount of battery power consumed for the dynamic functions to be activated;
acquiring a power storage magnitude indicating the remaining power of the battery; and
calculating the remaining battery life according to the first and second power consumption magnitudes and the power storage magnitude.

20. The method as claimed in claim 19 wherein the first power consumption magnitude indicates the amount of battery power consumed per minute when the portable electronic device with the new static settings is in standby mode, and is calculated by a formula:
$${IS}_{total} = {\sum }_{i = 1}^{n} Is [ i ] \times Ic [ i ] ,$$
n representing a quantity of static settings, Is[i] representing a magnitude indicating the amount of battery power consumed per minute for the ith static setting, Ik[i] representing a new enabling status for the ith static setting, when the new ith static setting is activated, Ic[i]=“1”, otherwise, Ic[i]=“0”, the second power consumption magnitude indicates the amount of battery power consumed per minute for the dynamic functions potentially to be activated, and is calculated by a formula:
$${ID}_{total} = ( {\sum }_{j = 1}^{m} Id [ j ] \times Ix [ j ] ) / 1440 ,$$
m representing a quantity of dynamic functions, Id[j] representing a magnitude indicating the amount of battery power consumed per minute for the jth dynamic function, and Ix[j] representing an average usage time (in minutes) per day for the jth dynamic function, and, the remaining battery life is calculated by a formula,
Tr=Bₜₒₜₐₗ/(ISₜₒₜₐₗ+IDₜₒₜₐₗ),
Bₜₒₜₐₗ representing the acquired power storage magnitude, ISₜₒₜₐₗ representing the first power consumption magnitude, and IDₜₒₜₐₗ representing the second power consumption magnitude.

21. A device for battery power management of an electronic system, comprising:
a battery; and
a control unit coupling to the battery, receiving a request signal, calculating the remaining battery life after admitting the request signal, and notifying a prompt message comprising the remaining battery life to prompt users to confirm whether that the portable electronic device executes an operation corresponding to the request signal,
wherein the request signal indicates that one of plurality of dynamic functions is desired to be activated, or indicates that a plurality of original static settings are desired to be changed with a plurality of new static settings, and the operation activates the requested dynamic function or changes the original static settings with the new static settings.

22. The device as claimed in claim 21 wherein the request signal indicates that the dynamic functions is desired to be activated, the operation activates the requested dynamic function, and the control unit further calculates a first power consumption magnitude indicating the amount of battery power consumed when the portable electronic device is in standby mode, estimates a second power consumption magnitude indicating the amount of battery power consumed for the dynamic functions potentially to be activated, acquires a power storage magnitude indicating the remaining power of the battery and calculates the remaining battery life according to the first and second power consumption magnitudes and the power storage magnitude.

23. The device as claimed in claim 21 wherein the request signal indicates that the original static settings are desired to be changed with the new static settings, and the operation changes the static settings with the new static settings, and the control unit further calculates a first power consumption magnitude indicating the amount of battery power consumed when the portable electronic device with the new static settings is in standby mode, estimates a second power consumption magnitude indicating the amount of battery power consumed for the dynamic functions to be activated, acquires a power storage magnitude indicating the remaining power of the battery and calculates the remaining battery life according to the first and second power consumption magnitudes and the power storage magnitude.

24. The device as claimed in claim 21 further comprising a screen, wherein the control unit directs the screen to display the prompt message comprising the remaining battery life.

25. A method for battery power, management, performed by a portable electronic device powered by a battery, comprising:
estimating a power consumption magnitude indicating the amount of battery power consumed for a dynamic function to be activated;
acquiring a power storage magnitude indicating the remaining power of the battery; and
calculating the remaining battery life according to the power consumption magnitude and the power storage magnitude.

26. The method as claimed in claim 25 wherein the second power consumption magnitude indicates the amount of battery power consumed per minute for the dynamic function to be activated, and is calculated by a formula:
$${ID}_{total} = ( {\sum }_{j = 1}^{m} Id [ j ] \times Ix [ j ] \times If [ j ] ) / 1440 ,$$
m representing a quantity of dynamic fimctions, Id[j] representing a magnitude indicating the amount of battery power consumed per minute for the jth dynamic function, Ix[j] representing an average usage time (in minutes) per day for the jth dynamic function, and If[J] representing an enabling status for the jth dynamic function, when the jth dynamic function is activated; If [i]=“1”, otherwise, If [i]=“0”.
